(19) United States
(12) Patent Application Publication
(10) Pub. No.: US 2016/0284000 A1
(43) Pub. Date: Sep. 29, 2016

(54) SYSTEMS AND METHODS FOR INDICATING CONTENT CHARACTERISTICS OF SPACED-APART AREAS IN A RETAIL ENVIRONMENT

(71) Applicant: Toshiba Global Commerce Solutions Holdings Corporation, Tokyo (JP)

(72) Inventors: Susan Brosnan, Raleigh, NC (US); David Klages, Morrisville, NC (US); Jessica Snead, Cary, NC (US); Patricia Stephany Hogan, Raleigh, NC (US); Daniel Goins, Wake Forest, NC (US)

(21) Appl. No.: 14/669,598

(22) Filed: Mar. 26, 2015

(51) Int. Cl. G06Q 30/06

(52) U.S. Cl. CPC G06Q 30/0627; G06Q 30/0639

(57) ABSTRACT

Systems and methods for indicating content characteristics of spaced-apart areas in a retail environment are disclosed. According to an aspect, a system includes an item identifier for identifying an item. Detectors are placed at different spaced-apart areas and configured to detect the placement of items at the spaced-apart areas. The system may also include one or more indicators configured to indicate content characteristics of each of the spaced-apart areas. The system may also include an item processing manager configured to receive identification of the item from the item identifier. The item processing manager may determine placement of the item at one of the areas based on a detection of the placement of the item at that area. The item processing manager may also control the indicator to indicate one of the content characteristics based on the identification of the item in response to determining placement of the item at the respective area.

### TECHNICAL FIELD

The present subject matter relates to retail systems and techniques. More particularly, the present subject matter relates to systems and methods for indicating content characteristics of spaced-apart areas in a retail environment.

### BACKGROUND

In retail environments such as checkout areas, most checkout terminals are associated with a bagging area containing multiple spaced-apart areas for placing items simultaneously. Some or all of the spaced-apart areas may contain one or more bags for the placement of items within. Items are typically organized in the spaced-apart areas to prevent items from damaging or contaminating each other. For example, cold items may be placed together in one area for bagging, fragile items in another area, and cleaning items in yet another area. Bags may be opened in these different areas such that the items are separately bagged as desired.

However, organizing items in such a manner may be laborious and error-prone. For example, a cashier or bagger operating a checkout terminal may need to double-check bags at the different areas before adding new items to ensure items placed in the bags are organized properly. Additionally, the cashier or bagger may make mistakes and place new items in incorrect bags causing potentially damaged or spoiled items. Also, bags may be inadvertently overfilled such that the bags break or burst upon lifting or carrying. For at least these reasons, there is a need for improved techniques for managing items for bagging in a retail environment.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of an example system for indicating content characteristics of multiple spaced-apart areas in accordance with embodiments of the present disclosure;

FIG. 2 is a flowchart of an example method for controlling indicators to indicate a characteristic of a spaced-apart area based on identification of an item in response to determining placement of the item at the spaced-apart area in accordance with embodiments of the present disclosure;

FIG. 3 is a flowchart of an example method for controlling an indicator to indicate a characteristic based on the determination a weight of items at an area meets a predetermined threshold in accordance with embodiments of the present disclosure; and

FIG. 4 is a flowchart of an example method for controlling at least one indicator of the plurality of indicators to indicate a recommendation to remove all items placed at one of the spaced-apart areas in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

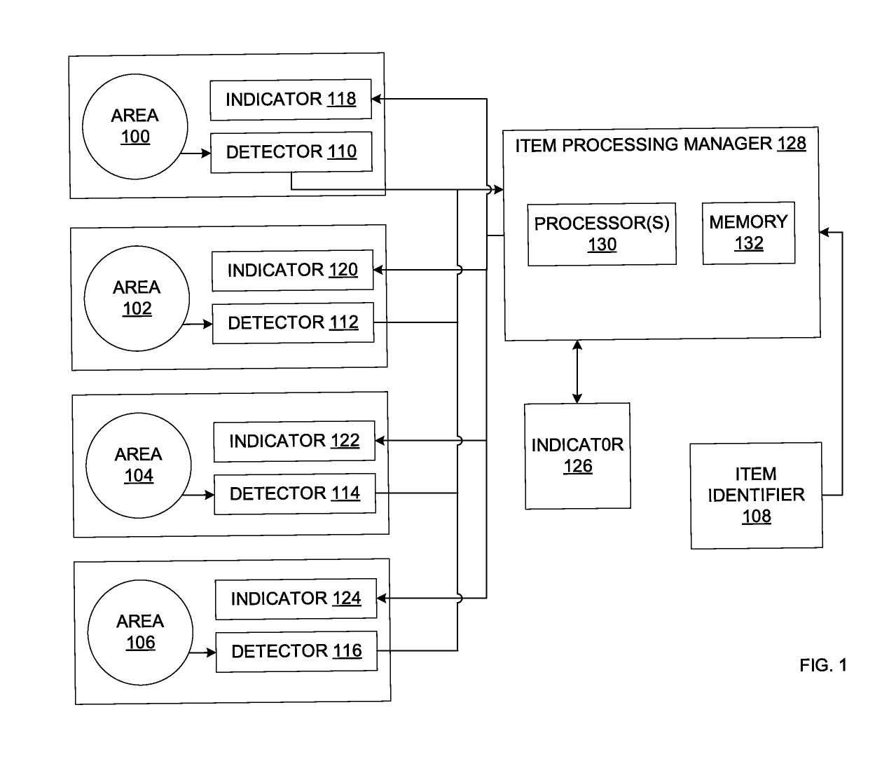

The present disclosure is now described in more detail. For example, FIG. 1 illustrates a block diagram of an example system for indicating content characteristics of spaced-apart areas 100-106 in accordance with embodiments of the present disclosure. The system of FIG. 1 may be, for example, a checkout system in a retail environment. For example, the checkout system may be implemented at a self-checkout terminal of a grocery store or other “brick-and-mortar” store. Each of the spaced-apart areas 100-106 may be an area for placement of a bag within which items may be placed during a checkout process. The areas 100-106 may each include a platform and supports for holding a bag, such as a plastic bag, while items being purchased are placed therein. However, it should be understood that any type of spaced-apart area designed for the placement of items during a checkout process may be used in accordance with embodiments of the present disclosure and are not limited to the examples provided herein above and below.

The system shown in FIG. 1 may include an item identifier 108 configured to identify an item. For example, the item identifier 108 may be a scanner. The scanner can be configured to scan a bar code, such as a universal product code (UPC) code, a quick response (QR) code, or the like, to identify an item. Information read by the scanner may be used as described herein for guiding placement of the associated item in one of the spaced-apart areas 100-106. In accordance with embodiments, the item identifier may be configured to receive an input identifying the item. For example, item identifie 108 may also comprise an interface for receiving an input identifying the item. The input may comprise information identifying the item. For example, the information may comprise a produce code. However, it should be understood that any type identifier configured for identification of items may be used in accordance with embodiments of the present disclosure and are not limited to the examples provided herein above and below.

The system may also include multiple detectors 110-116. Each detector 110-116 may be placed at a respective one of the spaced-apart areas 100-106. As an example, a detector may be a weight sensor configured to weigh items placed on a platform at a respective spaced-apart area 100-106 as will be understood by those of skill in the art. Alternatively, for example, a detector may be any suitable device or equipment configured to recognize the presence and characteristic of an item placed at a respective area 100-106.

The system may include indicators 118, 120, 122, and 124 configured to indicate a one or more content characteristics of a respective area 100-106. In accordance with embodiments, the at least one indicator 118, 120, 122, and/or 124 may include an illuminating device configured to emit light of multiple colors. For example, the indicators 118, 120, 122, and 124 may each include one or more light emitting diodes configured to emit light of different colors. Each of the content characteristics may be associated with at least one of the colors such that it is understood that the content characteristic has been determined when its associated color is presented.

As an example, Table A demonstrates example content characteristics associated with various colors. The content characteristics may include multiple product categories associated with items identified by the item identifier. It should be understood that any type of content characteristic may be associated with any color, and may be used in accordance with embodiments of the present disclosure. The example provide provided in Table A should not be construed as limiting.

TABLE A

| Content Characteristic | Color |
|---|---|
| Produce | Green |
| Raw Meat | Pink |
| Refrigerated/Frozen | Blue |
| Grocery | Orange |
| Fragile | Purple |
| Cleaning Supply | Yellow |
| Overweight | Red |
| Empty | None |

With continuing reference to FIG. 1, an indicator 126 may be configured to indicate a content characteristics of each of the spaced-apart areas 100-106. In accordance with embodiments, the indicator 126 may be a display controlled to display at one or more content characteristics determined for the spaced-apart areas. For example, the display may display a graphical representation of the spaced-apart areas 100-106 such as by displaying multiple boxes in an arrangement corresponding to the arrangement of areas 100-106. Icons, colors, text, or other suitable indicia may be displayed within one of the displayed boxes for indicating content characteristic(s) of the respective area 100-106. For example, each of the spaced-apart areas 100-106 may be color coded within the graphical representation based on the content characteristic(s) for each of the spaced-apart areas 100-106. Alternatively, or in addition to, each of the space-apart areas 100-106 may be labeled with one or more content characteristics shown in the example of Table A.

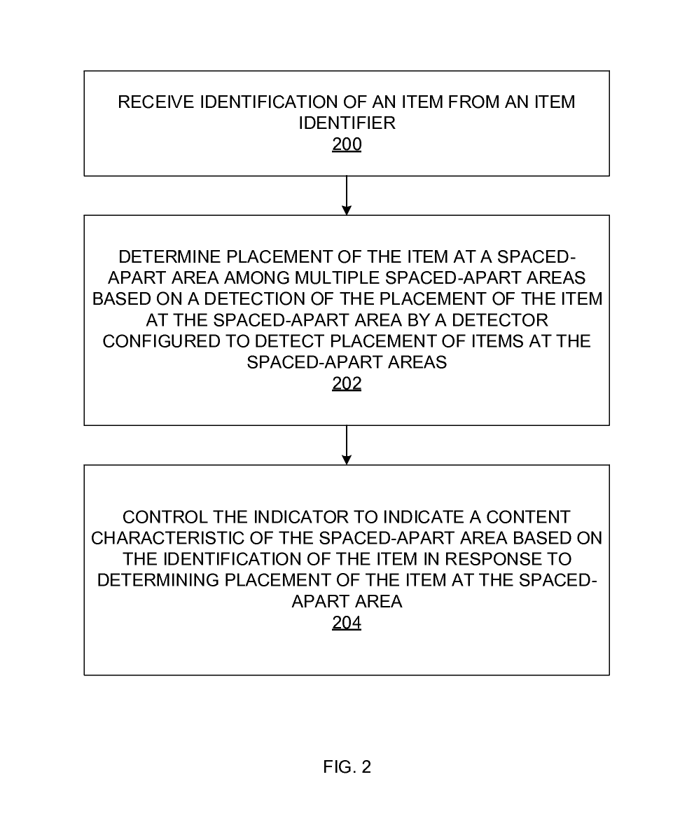

The system may include an item processing manager 128 configured to implement functionality described herein. The item processing manager 128 may include hardware, software, firmware, or combinations thereof. For example, the item processing manager 128 may include one or more processors 130 and memory 132 configured to perform a method for controlling one or more indicators to indicate a characteristic of an area based on identification of an item in response to determining placement of the item at the area in accordance with embodiments of the present disclosure as illustrated in FIG. 2.

Referring to FIG. 2, the method may include receiving 200 identification of an item from an item identifier. For example, the item processing manager 128 may be configured to receive identification of an item from an item identifier 108. For example, the item processing manager 128 may be implemented in a computing device residing at a checkout terminal. The item identifier 108 may be a scanner coupled to the computing device at the checkout terminal. The item processing manager 128 may suitably receive, from the item identifier 108, data indicating identification of an item, such as a grocery item.

The method of FIG. 2 includes determining 202 placement of the item at a spaced-apart area based on a detection of the placement of the item at the spaced-apart area by a detector configured to detect the placement of items at the spaced-apart areas. Continuing the aforementioned example, the item processing manager 128 may determine placement of the item at one of the spaced-apart areas 100-106 based on a detection of the placement of the item at the spaced-apart area by a detector among detectors 110-116 configured to detect the placement of items at the spaced-apart areas 100-106. In an example, the determination 202 of placement of an item at an area may include receiving a communication indicating detection of the placement of the item at the spaced-apart area. The communication may indicate a detected weight of the item placed at the space-apart area. Continuing the aforementioned example of a grocery item, the item processing manager 128 may receive a communication indicating detection of the grocery item at the spaced-apart area 100. In this example, the item processing manager 128 may receive the communication from detector 110 indicating the detected weight of the grocery item placed at spaced-apart area 100.

The method of FIG. 2 includes controlling 204 an indicator to indicate a content characteristic of the spaced-apart area based on the identification of the item in response to determining placement of the item at the spaced-apart area. For example, the item processing manager 128 may control indicators 118, 120, 122, 124, and/or 126 to each indicate a content characteristic of a respective spaced-apart area, such as area 100, based on the identification of the item in response to determining placement of the item at the area 100. In accordance with embodiments, the method may also include selecting the content characteristic based on the identification of the item.

Continuing with the example of a grocery item, the item processing manager 128 may select a content characteristic from Table A based on the identification of the grocery item. For example, the item processing manager 128 may identify the grocery item as a carton of eggs. In this example, the item processing manager 128 may select the characteristic “Fragile” since a carton of eggs may be easily broken by placement of other items in the same bag or area. The item processing manager 128 may subsequently indicate the content characteristic of the spaced-apart area 100 by controlling indicator 118 to illuminate the color purple. The item processing manager 128 may also indicate the content characteristic of the area 100 by controlling indicator 126 to display a color coded graphical representation of the spaced-apart areas 100-106. In this example, a graphical representation of spaced-apart area 100 may be highlighted in purple. Alternatively, or in addition to, the graphical representation of the area 100 may be illuminated with the color or otherwise identified with the characteristic of “Fragile.”

Providing to a retail personnel or other operator a content characteristic indication as disclosed herein may assist with the placement of items in the spaced-apart areas 100-106. For example, the labeling of an area as “Fragile” can indicate to a retail personnel not to place a container of milk in an associated area. Thus, the user can seek to place the container of milk in one of the other spaced-apart areas 102-106. As an example, the item processing manager 128 may implement the functionality of the method of FIG. 2 to indicate the content characteristic of a spaced-apart area.

In another example, the item processing manager 128 may select a content characteristic from Table A based on the identification of a container of milk. The item processing manager 128 may select the content characteristic “Refrigerated/Frozen” based on the knowledge that a container of milk requires refrigeration. The item processing manager 128 may control the indicator 120 to illuminate the color blue. The item processing manager 128 may indicate the content characteristic of the area 102 by controlling indicator 126 to display a color coded graphical representation of the spaced-apart areas 100-106. In this example, the graphical representation of area 102 may be illuminated by the color blue. Alternatively, or in addition to, the graphical representation of the spaced-apart area 102 may be labeled with the content characteristic of “Refrigerated/Frozen.” In this way, the item processing manager 128 may indicate the content characteristics of each spaced-apart areas 100-106 as a user places items in the spaced-apart areas 100-106.

In accordance with embodiments, the method may also include controlling the at least one indicator to indicate multiple content characteristics of the plurality of content characteristics of the spaced-apart area based on the identification of multiple items detected at the spaced-apart area. For example, item processing manager 128 may be configured to control indicator 118 to indicate multiple content characteristics of the plurality of content characteristics of Table A of area 100 based on the identification of multiple items detected at area 100. In this example, item processing manager 128 may control indicator 118 to illuminate the colors purple and orange based on the identification of a carton of eggs and a box of tea bags detected at the area 100. Alternatively, or in addition to, the graphical representation of the area 100 may be labeled with the content characteristics of “Fragile” and “Grocery.” In this way, the item processing manager 128 may indicate multiple content characteristics of each spaced-apart areas 100-106 as a user places items associated with multiple content characteristics in the spaced-apart areas 100-106.

In an alternative embodiment, the method may also include controlling the at least one indicator to indicate a priority content characteristic of the plurality of content characteristics of the spaced-apart area based on the identification of multiple items detected at the spaced-apart area. For example, the item processing manager 128 may be configured to control indicator 118 to indicate a priority content characteristics of the plurality of content characteristics of Table A of area 100 based on the identification of multiple items detected at area 100. In this example, the item processing manager 128 may determine placement of multiple items, such as a carton of eggs and a box of tea bags, at area 100. In response, the item processing manager 128 may control indicator 118 to illuminate the color purple based on the identification of the carton of eggs. In this example, the content characteristic “Fragile,” associated with the carton of eggs, may have a higher priority than “Grocery,” which may be associated with the box of tea bags, to prevent future placement of items that may damage the carton of eggs at area 100. Alternatively, or in addition to, the graphical representation of the area 100 may be labeled with the priority content characteristics of “Fragile.” In this way, the item processing manager 128 may indicate a priority content characteristic of each spaced-apart areas 100-106 as a user places items associated with priority content characteristics in the spaced-apart areas 100-106.

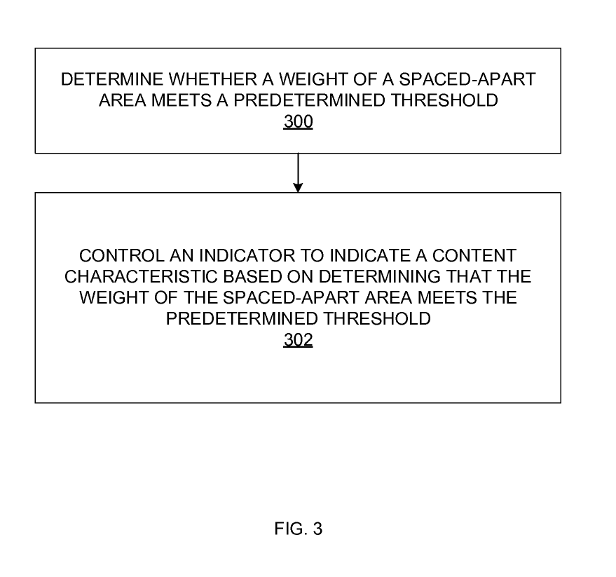

FIG. 3 illustrates a flowchart of an example method for controlling an indicator to indicate a characteristic based on the determination that a weight of items at an area meets a predetermined threshold in accordance with embodiments of the present subject matter. The method may be implemented, for example, by the item processing manager 128 shown in FIG. 1, or any other suitable system.

Referring to FIG. 3, the method may include determining 300 whether a weight at a spaced-apart area meets a predetermined threshold. For example, the item processing manager 128 may determine whether a weight at the spaced-apart area 102 shown in FIG. 1 meets a predetermined threshold weight. In accordance with embodiments, the predetermined threshold may define a maximum weight associated with the area 102. Further, a predetermined threshold may be used to define a minimum weight associate with the area 102. In this example, if a user places another item, such as a container of orange juice, at the area 102, the item processing manager 128 may compare the detected weight at the area 102 to the defined maximum weight and minimum weight associated with the area 102. For example, the maximum weight associated with spaced-apart area 102 may be ten (10) pounds, and the minimum weight associated with the area 102 may be one (1) pound.

The method of FIG. 3 includes controlling 302 an indicator to indicate a characteristic based on determining that the weight of the spaced-apart area meets the predetermined threshold. Continuing the aforementioned example regarding the quart of orange juice, the item processing manager 128 may be configured to control the indicator 120 and/or 126 to indicate that the weight of spaced-apart area 102 is overweight based on the determination the detected weight of spaced-apart area 102 exceeds a maximum weight associated with spaced-apart area 102. In this example, the combined weight of the gallon of milk and quart of orange juice is determined to exceed the maximum weight of ten pounds associated with area 102.

In this example, the item processing manager 128 may indicate the “Overweight” characteristic (shown in the example of Table A) of the spaced-apart area 102 by controlling the indicator 120 to illuminate the color red. As stated previously, the item processing manage 128 may indicate the “Overweight” characteristic of the area 102 by controlling the indicator 126 to display a color coded graphical representation of the spaced-apart areas 100-106. In this example, the spaced-apart area 102 may be illuminated with the color red. Alternatively, or in addition to, the graphical representation of the area 100 may be suitably labeled with the characteristic “Overweight.” In this way, a user of the system of FIG. 1 may remove the quart of orange juice from a bag at the area 102 after being alerted to the overweight characteristic.

In another example, the user of the system of FIG. 1 may remove a carton of eggs from an area, such as area 100. In this example, the item processing manager 128 may compare the detected weight of the area 100 to one or both of a maximum weight and a minimum weight associated with the area 100. The item processing manager 128 may control the indicator 118 and/or indicator 126 to indicate that the area 100 is “Empty” based on the determination the detected weight of spaced-apart area 102 meets a minimum weight associated with area 100. In this example, the item processing manager 128 may indicate the “Empty” characteristic of the spaced-apart area 102 by controlling the indicator 120 to not illuminate. As stated previously, the item processing manager 128 may indicate the “Empty” characteristic of the spaced-apart area 100 by controlling indicator 126 to display a color-coded graphical representation of the spaced-apart areas 100-106. In this example, the graphical representation of the area 100 may not be illuminated with a color. Alternatively, or in addition to, the graphical representation of the area 100 may be labeled with the characteristic of “Empty.”

In accordance with embodiments, the method may also include controlling an indicator to indicate a recommendation to remove all items placed at the spaced-apart area in response to determining that the weight of the spaced-apart area meets the predetermined threshold. Continuing the aforementioned example regarding the gallon of milk, the item processing manager 128 may control the indicator 120 and/or indicator 126 to indicate a recommendation to remove all items placed in a bag at the area 102 in response to determining that the weight of the area 102 meets the predetermined threshold. In this example, the weight of the gallon of milk may meet a maximum weight associated with area 102. In accordance with embodiments, the indicator may flash a visible signal intermittently to indicate a recommendation to remove all items placed at the spaced-apart area. In this example, the indicator 120 may be configured to flash intermittently until it is detected that the item (e.g., gallon of milk) is removed from the area 102. There also may be instances when items may have been placed at all of the spaced-apart areas 100-106 and yet there may be more items for placement at the spaced-apart areas 100-106. For example, a user of the system of FIG. 1 during a checkout process may find it difficult to determine which items placed at spaced-apart areas 100-106 should be removed in order to place future items at the spaced-apart areas 100-106. The method and system of the present disclosure may be utilized to address such a problem as described herein below.

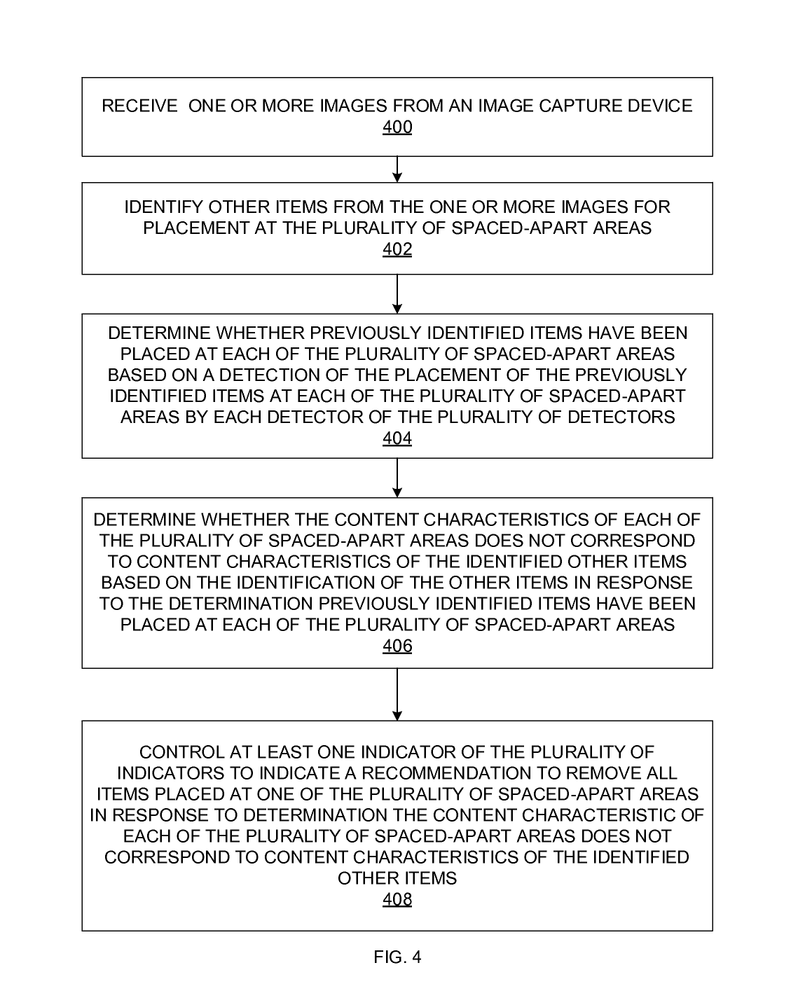

FIG. 4 illustrates a flowchart of an example method for controlling at least one indicator of the plurality of indicators to indicate a recommendation to remove all items placed at one of the plurality of spaced-apart areas in accordance with embodiments of the present disclosure. The method may be implemented, for example, by the item processing manager 128 shown in FIG. 1, or any other suitable system.

Referring to FIG. 4, the method includes receiving 400 one or more images from an image capture device. For example, the item processing manager 128 may receive the image(s) from an image capture device. In accordance with embodiments, the image capture device may be a digital camera of a checkout terminal in a retail environment. The camera may include, but is not limited to, a camera configured to capture one or more images or video of items that have not been identified by the item identifier 108. For example, the camera may capture one or more images of items in a shopping cart.

The method of FIG. 4 may also include identifying 402 other items from the one or more images for placement atthe plurality of spaced-apart areas. For example, the item processing manager 128 may identify other items from captured image(s) for placement in a bag at one of the spaced-apart areas 100-106. In this example, the item processing manager 128 may identify from the captured image(s) that other items in the shopping cart yet to be identified by item identifier 108 only include produce items. In an example, the item processing manager 128 may identify the other items from the captured image(s) using a suitable image processing technique, such as image recognition technique or the like.

FIG. 4 illustrates the method may also include determining 404 whether previously identified items have been placed at each of the plurality of spaced-apart areas based on a detection of the placement of the previously identified items at each of the plurality of spaced-apart areas by each detector of the plurality of detectors. For example, item processing manager 128 may receive communications from each of the detectors 110-116 that previously identified items have been placed at each of the plurality of spaced-apart areas 100-106.

In accordance with embodiments, the method of FIG. 4 may also include determining 406 determine whether the content characteristics of each of the plurality of spaced-apart areas does not correspond to content characteristics of the identified other items based on the identification of the other items in response to the determination previously identified items have been placed at each of the plurality of spaced-apart areas. For example, the item processing manager 128 may have previously selected the content characteristics of each of the plurality of spaced-apart areas 100-106 as “Fragile,” “Refrigerated/Frozen,” “Raw Meat,” and “Grocery.” In this example, the item processing manager 128 may be configured to determine content characteristics of the other items based on the identification of the other items. Continuing the example, the item processing manager 128 may be configured to determine whether the determined “Produce” content characteristic of the other items does not correspond to the content characteristics “Fragile,” “Refrigerated/Frozen,” “Raw Meat,” and “Grocery” of the plurality of spaced-apart areas 100-106.

The method of FIG. 4 may also include controlling 408 control at least one indicator of the plurality of indicators to indicate a recommendation to remove all items placed at one of the plurality of spaced-apart areas in response to determination the content characteristic of each of the plurality of spaced-apart areas does not correspond to content characteristics of the identified other items. For example, the item processing manager 128 may control at least one of the indicators 118-124 and/or indicator 126 to indicate a recommendation to remove all items placed at one of the spaced-apart areas 100-106 in response to determining the content characteristics of the other items does not correspond to content characteristics of the spaced-apart areas 100-106. In this example, the item processing manager 128 may control indicator 118 to recommend removal of a carton of eggs from area 100, since the “Produce” content characteristic does not correspond to the “Fragile” content characteristic of area 100.

In accordance with embodiments, the item processing manager may select one of the plurality of spaced-apart areas to indicate a recommendation to remove all items placed at the selected spaced-apart area based on a weight of all items at the selected spaced apart area. For example, item processing manager 128 may be configured to select area 102 to indicate a recommendation to remove the container of milk based on the weight of the container of milk. In this example, the item processing manager 128 may control indicator 120 to recommend removal of the container of milk from area 102 so that the other items may be placed at area 102. As stated previously regarding FIG. 3, indicators 118 or 120 may flash a visible signal intermittently to indicate a recommendation to remove all items placed at areas 100 or 102. In this example, the indicator 118 may be configured to flash intermittently until it is detected that the items (e.g., container of milk and the carton of eggs) are removed from the areas 100 or 102. Alternatively, or in addition to, the item processing manager 128 may indicate the recommendation to remove all items from the areas 100 and/or 102 by controlling indicator 126 to display the recommendation on a graphical representation of the spaced-apart areas 100-106. In this example, the graphical representation of the areas 100 and/or 102 may be labeled with the text “Remove” to indicate a recommendation to remove all items from areas 100 and 102.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A system comprising:
an item identifier configured to identify an item;
a plurality of detectors configured to be placed at a plurality of spaced-apart areas, and configured to detect the placement of items at the spaced-apart areas;
at least one indicator configured to indicate a plurality of content characteristics of each of the spaced-apart areas; and
an item processing manager comprising at least one processor and memory configured to:
receive identification of the item from the item identifier;
determine placement of the item at one of the spaced-apart areas based on a detection of the placement of the item at the one of the spaced-apart areas; and
in response to determining placement of the item at the one of the spaced-apart areas, control the at least one indicator to indicate one of the content characteristics based on the identification of the item.

2. The system of claim 1, wherein the item identifier comprises a scanner.

3. The system of claim 1, wherein each of the plurality of detectors comprises a weight sensor configured to weigh the items placed at the spaced-apart areas.

4. The system of claim 1, wherein the at least one indicator comprises an illuminating device configured to emit light of a plurality of colors.

5. The system of claim 4, wherein each of the plurality of content characteristics are associated with at least one of the plurality of colors.

6. The system of claim 1, wherein the at least one indicator comprises a display configured to display at least one characteristic of the plurality of content characteristics for each of the spaced-apart areas.

7. The system of claim 1, wherein the item processing manager is also configured to receive a communication comprising the detection of the placement of the item at the one of the spaced-apart areas.

8. The system of claim 1, wherein the item processing manager is also configured to select the one of the characteristics based on the identification of the item.

9. The system of claim 1, wherein the item processing manager is also configured to:
determine whether a weight of the one of the spaced-apart areas meets a predetermined threshold; and
control the at least one indicator to indicate one of the content characteristics based on the determination the weight of the one of the spaced-apart areas meets the predetermined threshold.

10. The system of claim 9, wherein the predetermined threshold comprises at least one of a maximum weight and a minimum weight associated with the one of the spaced-apart areas.

12. The system of claim 1, wherein the item identifier comprises an image capture device; and wherein the item processing manager is also configured to:
receive one or more images from the image capture device;
identify other items from the one or more images for placement at the plurality of spaced-apart areas;
determine whether previously identified items have been placed at each of the plurality of spaced-apart areas based on a detection of the placement of the previously identified items at each of the plurality of spaced-apart areas by each detector of the plurality of detectors;
in response to the determination previously identified items have been placed at each of the plurality of spaced-apart areas; determine whether the content characteristics of each of the plurality of spaced-apart areas does not correspond to content characteristics of the identified other items based on the identification of the other items; and
in response to determination the content characteristic of each of the plurality of spaced-apart areas does not correspond to content characteristics of the identified other items, control at least one indicator of the plurality of indicators to indicate a recommendation to remove all items placed at one of the plurality of spaced-apart areas.

13. The system of claim 1, wherein the plurality of content characteristics comprises a plurality of product categories associated with items identified by the item identifier.

14. A method, comprising:
at an item processing manager comprising at least one processor and memory:
receiving identification of an item from an item identifier;
determining placement of the item at a spaced-apart area of a plurality of spaced-apart areas based on a detection of the placement of the item at the spaced-apart area by a detector of a plurality of detectors configured to detect the placement of items at the plurality of spaced-apart areas; and
in response to determining placement of the item at the spaced-apart area, controlling at least one indicator to indicate a content characteristic of a plurality of characteristics of the spaced-apart area based on the identification of the item.

15. The method of claim 14, wherein determining placement of the item at the spaced-apart area comprises receiving a communication comprising the detection of the placement of the item at the spaced-apart area.

16. The method of claim 14, the method also comprising selecting the content characteristic based on the identification of the item.

17. The method of claim 14, the method also comprising:
determining whether a weight of the spaced-apart area meets a predetermined threshold; and
controlling the at least one indicator to indicate a content characteristic of the plurality of characteristics based on the determination the weight of the spaced-apart area meets the predetermined threshold.

18. The method of claim 17, wherein the predetermined threshold comprises at least one of a maximum weight and a minimum weight associated with the spaced-apart area.

19. The method of claim 14, wherein the item identifier comprises an image capture device; and the method also comprises:
receiving one or more images from the image capture device;
identifying other items from the one or more images for placement at the plurality of spaced-apart areas;
determining whether previously identified items have been placed at each of the plurality of spaced-apart areas based on a detection of the placement of the previously identified items at each of the plurality of spaced-apart areas by each detector of the plurality of detectors;
in response to determining previously identified items have been placed at each of the plurality of spaced-apart areas; determining whether the content characteristics of each of the plurality of spaced-apart areas does not correspond to content characteristics of the identified other items based on the identification of the other items; and
in response to determining the content characteristic of each of the plurality of spaced-apart areas does not correspond to content characteristics of the identified other items, controlling at least one indicator of the plurality of indicators to indicate a recommendation to remove all items placed at one of the plurality of spaced-apart areas.

20. The method of claim 14, wherein the plurality of content characteristics comprises a plurality of product categories associated with items identified by the item identifier
